(19) United States
(12) Patent Application Publication
(10) Pub. No.: US 2010/0111086 A1
(43) Pub. Date: May 6, 2010

(54) MULTICAST AND BIDIRECTIONAL UNICAST SIGNALING IN SINGLE ROOT MULTIPOINT SERVICES USING RSVP-TE

(75) Inventors: Benoit Tremblay, Laval (CA); András Kem, Budapest (HU); Attila Takács, Budapest (HU)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 12/580,530

(22) Filed: Oct. 16, 2009

Related U.S. Application Data
(60) Provisional application No. 61/111,364, filed on Nov. 5, 2008.

(51) Int. Cl. H04L 12/56

(52) U.S. Cl. 370/390

(57) ABSTRACT

A method for establishing a downstream multicast and a upstream and downstream unicast connections between a root and at least one leaf, the root and the at least one leaf being in a tree-type configuration, comprises: creating a downstream unicast label; and distributing the created downstream unicast label in a same signaling message as downstream multicast and upstream unicast labels from the root to the at least one leaf. A network node comprising such a downstream unicast label is used to carry out the method.

### PRIORITY STATEMENT UNDER 35 U.S.C. S.119(e) & 37 C.F.R. S.1.78

This non-provisional patent application claims priority based upon the prior U.S. provisional patent application entitled “MULTICAST AND BIDIRECTIONAL UNICAST SIGNALING IN SINGLE ROOT MULTIPOINT SERVICES USING RSVP-TE”, application No. 61/111,364, filed Nov. 5, 2008, in the names of Benoit Tremblay, Andras Kern and Attila Takacs.

### TECHNICAL FIELD

The present invention generally relates to Ethernet services in a communication network. More specifically, the present invention is concerned with a method and system for multicast and bidirectional unicast signaling.

### BACKGROUND

Traffic engineered point-to-point (PtP) Ethernet services are well understood and solutions for deploying them are already well documented. However, solutions for deploying multipoint services are emerging on the market and no complete solution has found general agreement. Metro Ethernet Forum (MEF) has defined the services (see [MEF 10.1]) but does not specify how to implement them. The IEEE Provider Backbone Bridging with Traffic Engineering (IEEE PBB-TE [802.1Qay]) is currently under development and a preliminary version of the specification proposes definitions for point-to-point and point-to-multiple point (PtMP) services.

The deployment of multipoint services is complex and operators need tools to facilitate the management of these services. For example, Generalized Multi-Protocol label Switching (GMPLS) defined by Internet Engineering Task Force (IETF [RFC3471, RFC3473]) and Ethernet specific extensions ([GELS]) offer a good start for deploying PtP services but still lack all the necessary extensions to support Ethernet multipoint services.

More specifically, the MEF has specified three major Ethernet service types: 1) a bidirectional point-to-point connectivity (E-LINE), 2) a rooted multipoint (E-TREE) connectivity and 3) a multipoint connectivity (E-LAN). However, the MEF does not define how these services will be implemented by the provider network. Any technologies can be used as long as the service definition is respected.

However, there is no solution that currently exists that allows an operator to provision MEF E-TREE and E-LAN services using a control plane. The present invention focuses on the problem of establishing rooted multipoint connectivity.

### SUMMARY

More specifically, in accordance with the present invention, there is provided a method for establishing a downstream multicast and a upstream and downstream unicast connections between a root and at least one leaf, the root and the at least one leaf being in a tree-type configuration. The method comprises the steps of creating a downstream unicast label and distributing the created downstream unicast label in a same signaling message as downstream multicast and upstream unicast labels.

The step of creating the downstream unicast label further comprises specifying a path between the root and the at least one leaf, a Media Access Control (MAC) address of the at least one leaf and a selected Virtual Local Area Network Identity (VLAN ID), in Provider Backbone Bridging with Traffic Engineering (PBB-TE) networks. The specified path is determined in the root or in a network node.

The step of distributing the created downstream unicast label further comprises using a Time-Length-Value (TLV) field of a PATH message to transport the created downstream unicast label.

The step of distributing the created downstream unicast label also comprises using an extension to a Source to Leaf sub_LSP (S2L-sub_LSP) object defined in a PATH message, wherein the extension comprises a new class of objects to be inserted in RSVP messages.

The step of distributing the created downstream unicast label further comprises using new objects for containing secondary labels in a PATH message, the secondary labels being used for unicast traffic, wherein the new objects comprise a new class of objects for containing the secondary labels.

The step of creating the downstream unicast label also comprises creating the downstream unicast label in the root or in a network node.

An aspect of the present invention also relates to a network node for establishing a downstream multicast and a upstream and downstream unicast connections between a root and at least one leaf, the root and the at least one leaf being in a tree-type configuration. The network node comprises an indicator of downstream unicast label, the indicator being inserted in a same signaling message as downstream multicast and upstream unicast labels.

The network node further comprises a label module for creating the indicator of downstream unicast label and an interface for inserting the indicator of downstream unicast label in the same signaling message as the downstream multicast and upstream unicast labels.

The indicator of downstream label can be provided in a Time-Length-Value (TLV) field of a PATH message, or in an extension to a Source to Leaf sub_LSP (S2L-sub_LSP) object defined in a PATH message, wherein the extension comprises a new class of objects to be inserted in RSVP messages.

The indicator of downstream label can be also provided in new defined objects for containing secondary labels in a PATH message, the secondary labels being used for unicast traffic, wherein the new defined objects comprise a new class of objects for containing the secondary labels.

Furthermore, the indicator of downstream unicast label comprises a path specified between the root and the at least one leaf, a MAC address of the at least one leaf and a selected Virtual Local Area Network Identity (VLAN ID), in Provider Backbone Bridging with Traffic Engineering (PBB-TE) networks, wherein the path between the root and the at least one leaf is specified by the root or by a network node.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a schematic view of an E-TREE service architecture according to a non-restrictive illustrative embodiment of the present invention;

FIG. 2 is a flow chart illustrating a method for establishing a downstream multicast and a upstream and downstream unicast connections in the E-TREE service architecture of FIG. 1, according to a non-restrictive illustrative embodiment of the present invention; and

FIG. 3 is a schematic diagram of a network node for establishing a downstream multicast and a upstream and downstream unicast connections in the E-TREE service architecture of FIG. 1, according to a non-restrictive illustrative embodiment of the present invention.

### DETAILED DESCRIPTION

Before describing some exemplary embodiments of the present invention, a list of acronyms, used in the present application, is provided.

List of Acronyms:
CE Customer Equipment
CBP Customer Backbone Port
E-LAN Ethernet LAN service—MEF specified service
E-LINE Ethernet line service—MEF specified service
E-Tree Ethernet tree service—MEF specified service
ESP Ethernet Switched Path
EVC Ethernet Virtual Circuit
GMPLS Generalized Multi-Protocol Label Switching
IANA Internet Assigned Numbers Authority
IETF Internet Engineering Task Force
I-SID Instance Service Identifier
ISIS-TE Intermediate System to Intermediate System-Traffic Engineering
LAN Local Area Network
LMP Link Management Protocol
LSP Label Switch Path
MAC Media Access Control (address)
MEF Metro Ethernet Forum
MPLS-TP Multi-Protocol Label Switching-Transport Profile
MPtP Multipoint-to-Point (connection)
MPtMP Multipoint-to-Multipoint (connection)
NMS Network Management System
OAM Operations Administration and Maintenance
PBB Provider Backbone Bridging
PBB-TE Provider Backbone Bridging with Traffic Engineering
PCE Path Computation Engine
PtP Point-to-Point (connection)
PtMP Point-to-Multipoint (connection)
OSPF-TE Open Shortest Path First-Traffic Engineering
RESV Reserve
RSVP-TE Resource Reservation Protocol—Traffic Engineering, Signaling protocol for (G) MPLS
SONET Synchronous Optical Network
SDH Synchronous Digital Hierarchy
TBA To Be Assigned
UNI User Network Interface
VLAN Virtual Local Area Network

In MEF, for example, the E-LINE service is a point-to-point Ethernet Virtual Connection (EVC) that interconnects exactly two User Network Interfaces (UNIs). The E-LINE is assumed to be bidirectional with symmetrical bandwidth. Asymmetric bandwidth reservation may be supported.

The E-TREE service or rooted multipoint EVC is a multipoint EVC that interconnects more than two UNIs such as to form a tree-type of configuration and in which each UNI is designated as either a Root or a Leaf. There may multiple roots in the E-TREE configuration. For example, frames presented at a root UNI can be sent to one or more other UNIs, which can be another root or leaves. And frames presented at a leaf UNI can be forwarded to some or all roots UNIs. However, in an exemplary embodiment of the present invention, a tree-type configuration of one root connected to several leaves will be described.

Ingress Service Frames at a Root UNI can be delivered to one or more of any of the other UNIs (the leaves) in the EVC. Ingress Service Frames at a Leaf UNI can only be delivered to one or more Root UNIs in the EVC. This means that a Customer Equipment (CE) connected at a root UNI can send frames to CEs connected to one or many UNIs (root or leaf) and that a CE connected at a leaf UNI can only send frames towards one or more root UNI but cannot send frames to any other leaf.

The E-LAN (or multipoint-to-multipoint EVC) defines connectivity between two or more UNIs. Each UNI can send frames to one, some, or all of the other nodes.

In terms of technologies, PBB-TE can be considered as one of the technologies that could be used to provide MEF services. In PBB-TE, connections are established by setting specific VLAN membership for port and adding static filtering entries in the nodes along the path. The source and destination of the connections are the customer backbone port (CBP) at the edge nodes.

The standard IEEE 802.1Qay defines two types of Traffic Engineered (TE) services: the PtP TE service and the PtMP TE service. These services consist of traffic engineered unidirectional connectivity paths, or so called Ethernet Switched Paths (ESPs). An ESP can be either point-to-point (regular path) or point-to-multipoint (multicast tree).

First, IEEE 802.1Qay defines the PtP TE service instance as: “A TE service instance supported by two point-to-point ESPs, where the ESPs' endpoints have the same CBP Media Access Control (MAC) addresses.”

Then, IEEE 802.1Qay defines PtMP TE service instance as: “A TE service instance supported by a set of ESPs which comprises one point-to-multipoint ESP from a root to n leaves plus n point-to-point ESPs from each of the leaves to the root.”

More specifically, the Point-To-Multipoint (PtMP) TE service in PBB-TE is a bidirectional multicast tree that contains at least 2 endpoints, one of which has a special role, this node being the root of the tree. The other endpoints correspond to the leaves. The root is able to send traffic to all leaves in a multicast way, while each leaf can send frames only to the root (unicast). This describes an 1:N relation between the root and the leaves, N being the number of leaves.

The MEF has specified its Ethernet Virtual Connection (EVC) services as an association between several UNIs but has not specified how a service instance should be implemented in networks with different technologies. Contrarily, in PBB-TE, the specified services are technology specific and they are valid only in PBB-TE networks. Furthermore, IEEE does not specify how the traffic at the UNIs is mapped in the TE services.

It should be noted that there is a distinction between the MEF single root multipoint (E-TREE) services and the PtMP TE service. In the latter case, a service frame presented at the root will always be delivered to all the leaves associated to the root, while this might not be the case in the MEF service, where a service frame presented at the root may be delivered to a single leaf or a subset of the leaves.

However, a MEF E-TREE service instance can be implemented with the help of a PtMP TE service instance and many PtP TE service instances. At the same time, a TE service instance can carry the traffic belonging to different MEF services, since the Edge nodes differentiate the traffic flows based on an additional service identifier, called the I-SID tag. Therefore, there is a many-to-many relation between the MEF and the TE services of PBB-TE.

Since both TE service types are defined as bidirectional, in a leaf-to-root direction, two parallel PtP ESPs will be established between each leaf-root pair: one for the PtMP and one for the PtP TE service instances. By default, the leaf node will forward over only one of the two ESPs, while the other ESP will not be used. Alternatively, the two TE service instances can share their upstream ESP.

Even though the PtP and PtMP TE service definitions are based on ESPs, there are no such managed objects in a PBB-TE node. Instead, the ESPs are built by changing port VLAN membership, adding static entries in the filtering database of the nodes involved in the ESPs and by creating Maintenance Associations that contain a set of Maintenance Endpoints (MEPs) on the edge nodes.

The connections required for the services can be established by a network management system (NMS). However, the main issue about NMSs is that they are usually proprietary and thus not interoperable with network nodes from multiple vendors. It may be difficult for an operator to establish services using an NMS in a network that contains equipment from different vendors.

The services can also be established by a distributed control plane. In that case, a single command to the root enables to configure all the nodes involved in the service. GMPLS is already recognized by the industry as a leading technology for controlling the network. It provides the protocols and procedures for discovering, for example, the links in the network (LMP), the network topology (OSPF-TE or ISIS-TE) and the signaling protocol to establish the connections (RSVP-TE). The RSVP-TE protocol has been defined by the IETF and many RFCs describe different aspects of the protocol. Since GMPLS is a set of standard protocols, the interoperability between vendors is highly increased.

RSVP-TE was originally developed to establish PtP connections. Some recent work has extended the protocol to support multicast trees. For example, RFC4875 described the required objects and procedures to establish a unidirectional PtMP service. However, this work focuses on MPLS data plane and does not consider specific requirements of other technologies, such as PBB-TE.

Some problems exist with the current solutions in RSVP-TE. For example, the current LSP constructs in RSVP-TE are point-to-point and unidirectional multicast point-to-multipoint. If one wants to deploy an E-TREE service as defined in MEF, a solution will be to build a point-to-multipoint LSP from the root to the leaves and many point-to-point bidirectional LSP from the root to each of the leaf.

The RSVP-TE extensions defined in [RFC 4875] establish a mechanism to signal point-to-multipoint trees. One assumption is that the data plane duplicates the frames such that each leaf receives a copy of the service frames received at the root. This can be achieved in PBB-TE networks by using a multicast address and setting the appropriate forwarding entries in the backbone to establish the path from the root to the leaves.

By combining RSVP-TE extensions defined for GMPLS ([RFC3471]), the multicast tree can easily be made bidirectional by adding the UPSTREAM_LABEL in the PATH message sent by the root node. The MAC address of the root CBP is used in the upstream label to establish the path from the leaves to the root. The procedures used to propagate the labels on the selected nodes should be those proposed in [GELS] to insure that the same label will be used from the root to the leaves (and vice-versa).

However, having a bidirectional tree is not enough for establishing a rooted-Multipoint EVC as defined by MEF because all the service frames received at the root UNI node are forwarded to all leaves. The service definition specifies that once a customer device is known to be connected to a leaf, the root should send traffic in unicast to that leaf rather than sending it to all leaves. This means that a unicast path from the root to each leaf must also be established and used.

To have an effective resource management and to ease the OAM, all the paths in the PBB-TE network should be co-routed. The signaling of these many LSPs needs to be coordinated from the NMS.

Currently, there are no existing or proposed extensions to RSVP-TE to support establishing the unicast and the multicast paths in the same signaling messages. Indeed, existing solutions send a first series of signaling messages for downstream multicast reservations and a second series of signaling messages for downstream and upstream (bidirectional) unicast reservations.

More specifically, to be able to establish a root-multipoint EVC, one should use a point-to-multipoint LSP to signal the multicast path from the root to the leaves first and then create for each leaf one bidirectional LSP between the root and that leaf. For the root node and intermediary nodes, this means maintaining up to N+1 LSPs where N is the number of leaves. Also each leaf should maintain 2 LSPs: the multipoint one and the unicast terminating on that node.

Furthermore, the establishment of the PtP LSPs and PtMP LSP must be coordinated. When a leaf is added or removed, the PtMP LSP must be modified in accordance with the PtP LSP creation or deletion. The path selected for the PtP LSP should preferably match the corresponding branch in the PtMP LSP.

Generally stated, embodiments of the present invention propose an indicator of downstream unicast label, in a form of extensions to RSVP-TE for example, to signal the required PtP connections at the same time as the PtMP connection is signaled. This is of particular interest, yet not exclusively, in PBB-TE networks.

As such, even though the PBB-TE networks are considered in the following examples, it should be noted that the embodiments of the present invention can be applied to other networks, such as Sonet/SDH or MPLS-TP.

More specifically, the embodiments of the invention allow for creating PtP connections between the root and the leaves in the same signaling session as the PtMP. These embodiments also address forwarding, from the root, unicast traffic to a single leaf or multicast traffic to all leaves, as well as setting a path for traffic from the leaves towards the root.

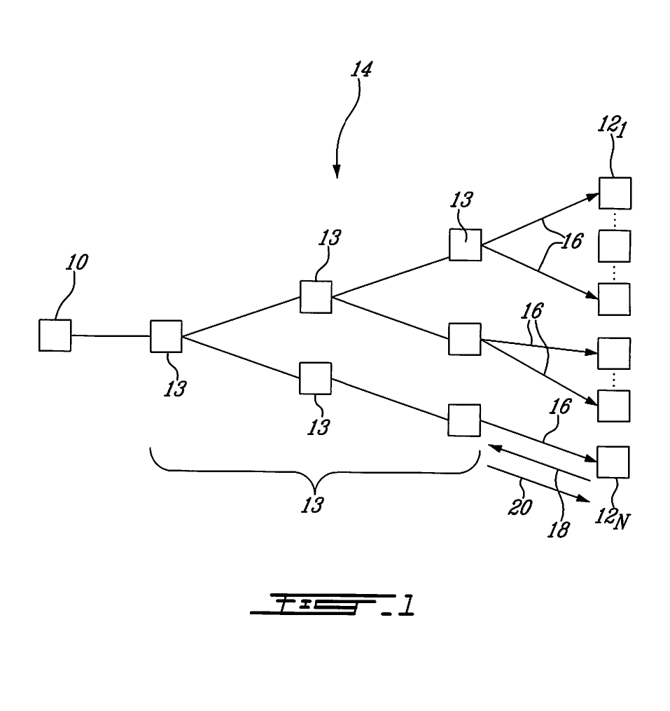

Now turning to FIG. 1, a schematic E-TREE service architecture 14 deployed in a PBB-TE network, for example, will be described. However, as mentioned above, other networks, such as GMPLS can be used as well.

The E-TREE service architecture 14 has a tree-type of configuration, where a node 10, called the root, is connected to a plurality of intermediate nodes 13, each one of them can be connected to further intermediate nodes 13. Thus, there can be several levels of intermediate nodes 13. As an illustrated example, FIG. 1 shows 3 levels of intermediate nodes 13. The intermediate nodes 13 of the last level are connected to a plurality of endpoint nodes 12₁ to 12_{N}, so as to form the tree-type of configuration. The endpoint nodes 12₁ to 12_{N} are identified as the leaves of the tree-type of configuration. The number of intermediate nodes 13 and endpoint nodes 12 depend on the complexity and size of a particular communication network.

Using RSVP-TE, establishment of label switched paths (LSPs) between the root 10 and the leaves 12₁ to 12_{N} can be performed. Furthermore, other considerations, such as network constraint parameters (available bandwidth and explicit hops, for example) are taken into account as well when using RSVP-TE.

There are two principal types of messages in RSVP-TE for LSPs establishment: the path messages (PATH) and the reservation messages (RESV).

The PATH messages are sent from a sender to receivers. They establish data flow identification state along the downstream path.

The RESV messages are sent from the receivers to the sender, carrying the reservation request and following the reverse path established by the PATH messages.

As mentioned hereinabove, an establishment of a LSP downstream multicast from the root 10 to all the leaves 12₁ to 12_{N} is possible, through the distribution of a downstream multicast label, by the PATH message. The LSP downstream multicast is shown by the arrows 16 in FIG. 1. An establishment of a LSP upstream unicast from the node 12_{N} to the root 10, for example, is also possible, as shown by the arrow 18, through the distribution of a upstream unicast label, by the PATH message. The establishment of the downstream multicast 16 and the upstream unicast 18 are requested at the same time in a same message.

Furthermore, with the embodiments of the present invention, establishment of a LSP downstream unicast from the root 10 to the leaf 12_{N} is also possible, the LSP downstream unicast is given by the arrow 20 in FIG. 1. The establishment of the LSP unicast downstream 20 is performed at the same time as the establishment of the LSP downstream multicast 16 and the LSP upstream unicast 18. To do so, the general idea is to have an indicator of downstream unicast label and to distribute the downstream unicast label within the PATH message along with the other labels.

Different mechanisms and procedures can be implemented in order to distribute the downstream unicast label in a same signaling as the downstream multicast label and upstream unicast label, as some examples will be described hereinbelow.

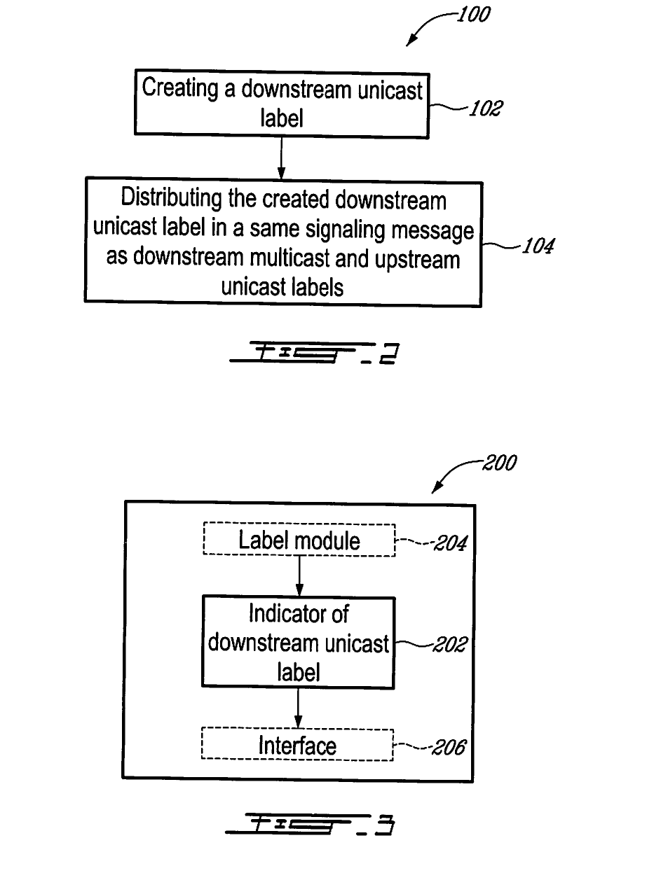

Now with reference to FIG. 2, a method 100 for establishing a downstream multicast and a upstream and downstream unicast connections between a root and at least one leaf, the root and the at least one leaf being in a tree-type configuration as illustrated in FIG. 1, for example, will be described.

Method 100 starts with step 102, where the root 10, or another network node, creates a downstream unicast label. An exemplary procedure for the creation of the downstream unicast label will be described hereinbelow. The other network node can be a Network Management System (NMS), which uses, for example, a centralized list of multicast addresses. This list is provided to the root 10 as part of the parameters for the tree-type of configuration 14, for example. It should be noted that usually unicast labels represent node addresses while multicast labels need to be allocated from a pool of possible addresses.

Then, in step 104, the root 10 distributes the created downstream unicast label in the same signaling message as the downstream multicast and upstream unicast labels to the at least one leaf. For example, the downstream unicast label can be inserted in the PATH message, sent by the root 10 to the at least one leaf, the PATH message also comprising the downstream multicast and upstream unicast labels.

Turning to FIG. 3, a network node 200 for establishing a downstream multicast and a upstream and downstream unicast connections between a root and at least one leaf, the root and the at least one leaf being in a tree-type configuration, will be described.

The network node 200, which can be a router or the root 10 (which can be also a router), for example, comprises an indicator 202 of downstream unicast label, the indicator 202 being inserted in a same signaling message as a downstream multicast and upstream unicast labels, the signaling message being a PATH message, for example. The PATH message is sent from the root 10 to one of the leaves 12n, for example. The indicator 202 of downstream unicast label can take many forms, as will be described hereinbelow.

The network node 200 may also comprise a label module 204 for creating the indicator 202 of downstream unicast label and an interface 206 for inserting the indicator 202 into the same signaling message as the downstream multicast and upstream unicast labels.

Of course, the network node 200 may also comprise a plurality of other components (not shown), such as, more specifically, a receiving module for receiving data packets from the leaves 12n, n=1 to N, an output for sending the data packets to the different leaves, a processor and/or memory, for performing tasks and procedures of the present invention and other usual tasks and procedures well known in the art.

As mentioned hereinabove, the indicator 202 of downstream unicast label may take many forms. Thus, in the following, non-restrictive illustrative examples of the indicator 202 according to the present invention will be described.

The first two illustrative examples require to use extensions of the RSVP-TE protocol for providing the indicator 202 and provide a mechanism for the root 10 to specify/insert the downstream unicast labels towards the leaves 12ₙ, for n=1 to N, in the PATH message.

However, the downstream label allocation is usually done by a remote end node. Also it is not always possible for the root node to determine the downstream label. For example, in PBB-TE networks, the downstream label contains the MAC address of the CBP on the leaf node which might not be known by the root node; in MPLS, a node does not know which labels are available on its neighbor. Also some of the existing RSVP objects are reused in different context (with different sub-object types) which may cause some backward compatibility issues.

The third illustrative example of the indicator 202 according to embodiments of the present invention introduces new objects that allow for a more flexible label allocation mechanism similar to the existing one for PtP connections.

The fourth non-restrictive illustrative example according to embodiments of the present invention is inspired by the third example but introduces new sub-object types instead of introducing new object types.

### Embodiment 1 of Example 1

### Extension to the LSP_ATTRIBUTE/LSP_REQUIRED_ATTRIBUTE Object of RSVP-TE

In this embodiment, the PATH message is augmented with a new Type-Length-Value (TLV), for providing the indicator 202, to distribute and transport the label for downstream unicast 20. More specifically, new Class types (C-Types) for the LSP_ATTRIBUTE and LSP_REQUIRED_ATTRIBUTES object classes of the PATH message are provided. For each leaf 12ₙ, for n=1 to N, for which a unicast traffic is required, the LSP_ATTRIBUTE or LSP_REQUIRED_ATTRIBUTE object with a C-type, respectively SUB LSP_ATTRIBUTE and/or SUB_LSP_REQUIRED_ATTRIBUTE, is added after the S2L_SUB_LSP object in the PATH message for that leaf 12ₙ. Also, the new TLV is added to transport the downstream unicast label.

Furthermore, according to this embodiment, the syntax of the PATH message is changed for the following:

<Path Message> ::= <Common Header> [ <INTEGRITY> ]

[ [<MESSAGE_ID_ACK> | <MESSAGE_ID_NACK>] ...]
[ <MESSAGE_ID> ]
<SESSION> <RSVP_HOP>
<TIME_VALUES>
[ <EXPLICIT_ROUTE> ]
<LABEL_REQUEST>
[ < PROTECTION> ]
[ <LABEL_SET> ... ]
[ <SESSION_ATTRIBUTE> ]
[ <NOTIFY_REQUEST> ]
[ <ADMIN_STATUS> ]
[ <POLICY_DATA> ... ]
<sender descriptor>
[<S2L sub-LSP descriptor list>]
<S2L sub-LSP descriptor list> ::= <S2L sub-LSP
descriptor>
[ <S2L sub-LSP descriptor list> ]

<S2L sub-LSP descriptor> ::= <S2L_SUB_LSP>

[ <P2MP SECONDARY_EXPLICIT_ROUTE> ]
[ <LSP_ATTRIBUTE> ]
[ <LSP_REQUIRED_ATTRIBUTE> ]

The new C-types are defined as:

| LSP_REQUIRED_ATTRIBUTES class = 67, | |
|---|---|
| C-Type | = 1 LSP_REQUIRED_ATTRIBUTE |
| | = 2 SUB_LSP_REQUIRED_ATTRIBUTE |
| LSP _ATTRIBUTES class = 197, | |
| C-Type | = 1 LSP_ATTRIBUTE |
| | = 2 SUB_LSP_ATTRIBUTE |

The new TLV is defined to include the downstream unicast label that declares or specifies the path from the root 10 to the leaf 12ₙ in the SUB_LSP_ATTRIBUTE object. In case of PBB-TE networks, the downstream unicast label will comprise of the MAC address of the leaf CBP and the selected VLAN-ID for the path, for example.

An example of the new TLV is shown below:

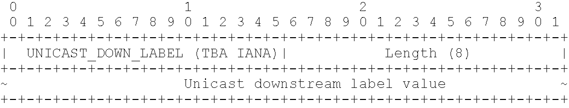

### Embodiment 2 of Example 2

### Extension to the S2L_SUB_LSP Object of RSVP-TE

In the second non-restrictive illustrative embodiment, an extension, such as a new C-type to the Source to Leaf sub-LSP (S2L_SUB_LSP) object, defined in [RFC4875] of the PATH message, is provided for providing the indicator 202. The C-types are for example class types. They identify class of objects that can be inserted in RSVP messages. The S2L_SUB_LSP object is used to describe a portion of the tree. The fields included in the new C-type still identify the end-point for the sub-LSP but now also includes the downstream unicast label. In case of PBB-TE networks, the downstream unicast label includes the CBP MAC address of the leaf 12ₙ and the selected VLAN-ID. The information given by the new C-type enables the intermediary nodes to establish the switching entries for the downstream unicast path from the root 10 to the leaf 12ₙ. The PATH message syntax is unchanged from the proposed syntax in [RFC 4875].

The new format for the S2L_SUB_LSP object of the PATH message is given hereinbelow. For example, a C-Type 3 (TBA by IANA) to S2L_SUB_LSP_IPv4_Unicast_Label contains the following fields:

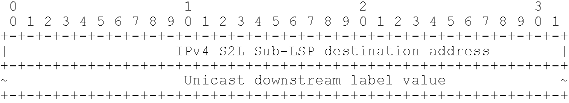

A C-Type 4 (TBA by IANA) to S2L_SUB_LSP_IPv6_Unicast_Label contains the following fields:

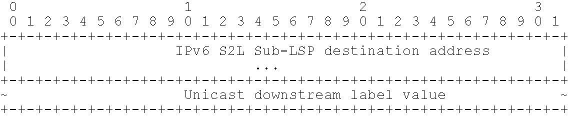

### Embodiment 3 of Example 3

### Definition of New SECONDARY_LABEL_REQUEST, SECONDARY_LABEL and SECONDARY_LABEL_SET Objects

In this embodiment, a set of three new objects is defined for providing the indicator 202: SECONDARY_LABEL REQUEST, SECONDARY_LABEL_SET and SECONDARY_LABEL. The SECONDARY_LABEL_REQUEST object has the same format as the LABEL_REQUEST object, the SECONDARY_LABEL_SET object has the same format as the LABEL_SET object and the SECONDARY_LABEL has the same format as the LABEL object. These objects and labels are termed “secondary” in order to distinguish them from the objects and labels used by all the leaves, i.e. the primary objects and labels. For example, each leaf supports two labels. The primary label is known by all leaves for the multicast traffic. The secondary label is specific to each leaf and is used for the unicast traffic.

One instance of the SECONDARY_LABEL_REQUEST object is added in the PATH message for each leaf 12ₙ for which the downstream unicast path is required. If the root 10 wants to specify the downstream label or include/exclude some label values, one or more SECONDARY_LABEL_SET objects may be included in the PATH message. These objects (SECONDARY_LABEL_REQUEST and SECONDARY_LABEL_SET) follow the S2L_SUB_LSP corresponding to the leaf 12ₙ for which the downstream unicast label is requested.

For each SECONDARY_LABEL_REQUEST included in the PATH message, the corresponding RESV message also includes a SECONDARY_LABEL object. The SECONDARY_LABEL object follows the corresponding S2L_SUB_LSP object. The procedure to select a secondary label is similar to the procedure for selecting the main label. This includes restriction on the possible label selection imposed by the SECONDARY_LABEL_SET object.

In the case of PBB-TE networks, the allocated downstream unicast label should include the MAC address of the CBP at the leaf node 12ₙ and the VLAN-ID used in the multicast label. For other data plane technologies, the label should be allocated according to the procedures applicable to each data plane technology.

These three objects and their identifying Class numbers (C-nums) are of the form “0bbbbbbb”, for example, to indicate that they can be understood by all the nodes and they are assigned by IANA. This value “0bbbbbbb” specifies that the value representing the class type has a zero (0) in its highest significant bit, indicating that this a standard object, which should be recognized and processed by all nodes involved in the signaling. Rules for identifying class types are defined in RFC 2205 section 3.10, for example.

Furthermore, a new SecondaryLabel sub-object has also been defined in the RECORD_ROUTE object to record the secondary label. This sub-object has the same format as the label sub-object but uses a different sub-object ID (TBA by IANA).

The resulting syntax of the PATH message according to the third embodiment is as follows:

<Path Message> ::= <Common Header> [ <INTEGRITY> ]

[ [<MESSAGE_ID_ACK> |
<MESSAGE_ID_NACK>] ...]
[ <MESSAGE_ID> ]
<SESSION> <RSVP_HOP>
<TIME_VALUES>
[ <EXPLICIT_ROUTE> ]
<LABEL_REQUEST>
[ <PROTECTION> ]
[ <LABEL SET> ... ]
[ <SESSION_ATTRIBUTE> ]
[ <NOTIFY_REQUEST> ]
[ <ADMIN_STATUS > ]
[ <POLICY_DATA> ... ]
<sender descriptor>
[<S2L sub-LSP descriptor list>]

<S2L sub-LSP descriptor list> ::= <S2L sub-LSP
descriptor>

[ <S2L sub-LSP descriptor list> ]

<S2L sub-LSP descriptor> ::= <S2L_SUB_LSP>

[<P2MP SECONDARY_EXPLICIT_ROUTE> ]
[<SECONDARY_LABEL_REQUEST> ]
[<SECONDARY_LABEL_SET> ... ]

The resulting syntax of the RESV message is as follows:

<Resv Messages ::= <Common Header> [ <INTEGRITY> ]

[ [<MESSAGE_ID_ACK> |
<MESSAGE_ID_NACK>] ... ]
[ <MESSAGE_ID> ]
<SESSION> <RSVP_HOP>
<TIME_VALUES>
[ <RESV_CONFIRM> ] [ <SCOPE> ]
[ <NOTIFY_REQUEST> ]
[ <ADMIN_STATUS> ]
[ <POLICY_DATA> ... ]
<STYLE> <flow descriptor list>

<flow descriptor list> ::= <FF flow descriptor list>

| <SE flow descriptor>

<FF flow descriptor list> ::= <FF flow descriptor>

| <FF flow descriptor list>
<FF flow descriptor>

<SE flow descriptor> ::= <FLOWSPEC> <SE filter spec
list>

<SE filter spec list> ::= <SE filter spec>

| <SE filter spec list> <SE filter spec>

The FF flow descriptor and SE filter specifications are modified as follows to identify the S2L sub-LSPs to which they correspond:

| | |
|---|---|
| <FF flow descriptor> ::= | [ <FLOWSPEC> ] <FILTER_SPEC> <LABEL> |
| | [ <RECORD_ROUTE> ] |
| | [ <S2L sub-LSP flow descriptor list> ] |
| <SE filter spec> ::= | <FILTER_SPEC> <LABEL> [ <RECORD_ROUTE> ] |
| | [ <S2L sub-LSP flow descriptor list> ] |

<S2L sub-LSP flow descriptor list> ::=

```
  <S2L sub-LSP flow descriptor>
  [ <S2L sub-LSP flow descriptor list> ]
```

<S2L sub-LSP flow descriptor> ::= <S2L_SUB_LSP>

```
    [ <P2MP_SECONDARY_RECORD_ROUTE> ]
    [ < SECONDARY_LABEL> ]
```

### Embodiment 4 of Example 4

### New C-Types Instead of New Object Types for Secondary Labels

Generally stated, the fourth non-restrictive illustrative embodiment allows for modifying the syntax of the PATH and RESV messages, by introducing multiple instances of existing objects.

For example, the SECONDARY_LABEL_REQUEST object, as described hereinabove, could instead be encoded as a new C-type in the LABEL_REQUEST object. This new C-type does not define any fields as the type of requested label is already specified in the primary LABEL_REQUEST object.

The SECONDARY_{— LABEL}_{— SET object could instead be implemented as being a new C-type for the LABEL}_SET object.

The SECONDARY_LABEL object could instead be encoded as a new C-type for the RSVP_LABEL object. The format of the object has the same format as the RSVP_LABEL object present in the RESV message.

However, it should be noted that introducing the multiple instances of an existing object that used to be present only once in the PATH and RESV messages may cause some backward compatibility issues with existing implementation of the protocol.

It should be also noted that an advantage of the illustrative embodiments of the present invention is to provide a mechanism to signal an E-TREE service as a single RSVP session allowing establishment of multicast and bidirectional unicast data paths in a reduced number of messages and in a coordinated way. The indicator 202, provided by the extensions to RSVP for example, allows for reducing the coordination required to establish an E-TREE service. It also reduces the number of messages exchanged between the nodes involved in the E-TREE service, such as the root 10 and the leaf 12ₙ.

A router or network node can be configured so as to process any of the above-mentioned embodiments of the present invention, i.e., to process the different PATH and/or RESV messages.

Although the present invention has been described in the foregoing specification by means of a non-restrictive illustrative embodiment, this illustrative embodiment can be modified at will within the scope, spirit and nature of the subject invention.

What is claimed is:

1. A method for establishing a downstream multicast and a upstream and downstream unicast connections between a root and at least one leaf, the root and the at least one leaf being in a tree-type configuration, the method comprising:
creating a downstream unicast label; and
distributing the created downstream unicast label in a same signaling message as downstream multicast and upstream unicast labels from the root to the at least one leaf.

2. A method as defined in claim 1, wherein creating the downstream unicast label comprises specifying a path between the root and the at least one leaf, a Media Access Control (MAC) address of the at least one leaf and a selected Virtual Local Area Network Identity (VLAN ID), in Provider Backbone Bridging with Traffic Engineering (PBB-TE) networks.

3. A method as defined in claim 2, wherein the specified path is determined in the root.

4. A method as defined in claim 2, wherein the specified path is determined in a network node.

5. A method as defined in claim 1, wherein distributing the created downstream unicast label comprises using a Time-Length-Value (TLV) field of a PATH message to transport the created downstream unicast label.

6. A method as defined in claim 1, wherein distributing the created downstream unicast label further comprises using an extension to a Source to Leaf sub_LSP (S2L-sub_LSP) object defined in a PATH message.

7. A method as defined in claim 6, wherein the extension comprises a new class of objects to be inserted in RSVP messages.

8. A method as defined in claim 1, wherein distributing the created downstream unicast label further comprises using new objects for containing secondary labels in a PATH message, the secondary labels being used for unicast traffic.

9. A method as defined in claim 8, wherein the new objects comprise a new class of objects for containing the secondary labels.

10. A method as defined in claim 1, wherein creating the downstream unicast label comprises creating the downstream unicast label in the root.

11. A method as defined in claim 1, wherein creating the downstream unicast label comprises creating the downstream unicast label in a network node.

12. A network node for establishing a downstream multicast and a upstream and downstream unicast connections between a root and at least one leaf, the root and the at least one leaf being in a tree-type configuration, the network node comprising:
an indicator of downstream unicast label, the indicator being inserted in a same signaling message as a downstream multicast and upstream unicast labels.

13. A network node as defined in claim 12, further comprising a label module for creating the indicator of downstream unicast label.

14. A network node as defined in claim 12, further comprising an interface for inserting the indicator of downstream unicast label in the same signaling message as the downstream multicast and upstream unicast labels.

15. A network node as defined in claim 12, wherein the indicator of downstream label is provided in a Time-Length-Value (TLV) field of a PATH message.

16. A network node as defined in claim 12, wherein the indicator of downstream label is provided in an extension to a Source to Leaf sub_LSP (S2L-sub_LSP) object defined in a PATH message.

17. A network node as defined in claim 16, wherein the extension comprises a new class of objects to be inserted in RSVP messages.

18. A network node as defined in claim 12, wherein the indicator of downstream label is provided in new defined objects for containing secondary labels in a PATH message, the secondary labels being used for unicast traffic.

19. A network node as defined in claim 18, wherein the new defined objects comprise a new class of objects for containing the secondary labels.

20. A network node as defined in claim 12, wherein the indicator of downstream unicast label comprises a path specified between the root and the at least one leaf, a MAC address of the at least one leaf and a selected Virtual Local Area Network Identity (VLAN ID), in Provider Backbone Bridging with Traffic Engineering (PBB-TE) networks.

21. A network node as defined in claim 20, wherein the path between the root and the at least one leaf is specified by the root.

22. A network node as defined in claim 20, wherein the path between the root and the at least one leaf is specified by a network node.
